(19) United States
(12) Patent Application Publication
(10) Pub. No.: US 2008/0295100 A1
(43) Pub. Date: Nov. 27, 2008

(54) SYSTEM AND METHOD FOR DIAGNOSING AND MANAGING INFORMATION TECHNOLOGY RESOURCES

(75) Inventor: John Ainsworth, Mount Sinai, NY (US)

Correspondence Address: PILLSBURY WINTHROP SHAW PITTMAN, LLP, P.O. BOX 10500, MCLEAN, VA, 22102, US

(73) Assignee: Computer Associates Think, Inc., Islandia, NY (US)

(21) Appl. No.: 11/753,973

(22) Filed: May 25, 2007

(51) Int. Cl. G06F 9/46

(52) U.S. Cl. 718/102

(57) ABSTRACT

A system and method for diagnosing and managing resources in an information technology (IT) infrastructure is provided. The system and method may include storing information relating to a plurality of IT resources, business processes that use the IT resources, and services that support the business processes. Associations may be generated among the IT resource information, the business process information, and the service information. As such, when a change in status occurs for any of the IT resources, the business processes, or the services, the generated associations may be used to determine an impact on other IT resources, business processes, or services.

### FIELD OF THE INVENTION

The invention relates generally to modeling information technology systems, and more particularly, to diagnosing and managing resources used to provide information technology infrastructure.

### BACKGROUND OF THE INVENTION

An information technology (IT) infrastructure often includes numerous diverse resources, such as various physical and virtual devices, interconnected networks, cumbersome and difficult to manage enterprise applications, and storage devices, among other things. Each of the components may often support various business processes of an enterprise using the IT infrastructure. When components fail, come under heavy demand, become obsolete, or otherwise require management for optimal business operation, supported business processes may be severely impacted by downtime, unavailable resources, or other consequences thereof. As such, a critical aspect of managing a large IT infrastructure often requires accurate and reliable diagnosis of dependencies between infrastructure resources and supported business processes.

### SUMMARY OF THE INVENTION

According to various aspects of the invention, a system and method for diagnosing and managing resources in an information technology (IT) infrastructure may address various drawbacks of existing systems. The invention may include storing information relating to a plurality of IT resources, business processes that use the IT resources, and services that support the business processes. Associations may be generated among the IT resource information, the business process information, and the service information. Using the generated associations, information relating to any business process may be visually represented, including definitions, capabilities, costs, or statuses relating to IT services being used to implement activities associated with the business processes. Further, when the status changes for any of the IT resources, the business processes, or the services, the generated associations may be used to determine an impact on other IT resources, business processes, or services. As such, business processes may be represented or manipulated using various levels of detail decomposition (e.g., a business process may be associated with a service at a low level of abstraction, and information about the association may automatically be propagated to higher levels of abstraction). Accordingly, the invention may be used for displaying a business process dashboard to depict the status of a business process (e.g., including a relationship to IT infrastructure or services), presenting a service's value to users via usage information, or facilitating interaction among business process owners and IT staff using a common visualization, among other things.

Other objects and advantages of the invention will be apparent to those skilled in the art based on the following drawings and detailed description.

### BRIEF DESCRIPTION OF THE DRAWINGS

FIG. 1 illustrates a block diagram of an exemplary three-layer information technology infrastructure for an enterprise.

FIG. 2 illustrates a block diagram of an exemplary implementation of a system for diagnosing and managing an information technology infrastructure according to various aspects of the invention.

### DETAILED DESCRIPTION

According to various aspects of the invention, a business, enterprise, or other organization may often employ a large information technology (IT) infrastructure to support various business processes. For instance, the IT infrastructure may include a large number of resources, including physical and virtual devices (e.g., workstations, servers, application portals, etc.), interconnected network components (e.g., switches, routers, hubs, etc.), cumbersome and difficult to manage enterprise applications (e.g., customer relationship managers, network administration tools, etc.), or storage devices (e.g., central data repositories, tape backup drives, etc.), among various other resources, as will be apparent. Various business processes (e.g., business-related work activities) may use the IT resources to implement organizational objectives for the business, enterprise, or other organization, while various services may support the business processes (e.g., ensuring availability, fast response times, data integrity, or other services for an e-commerce business).

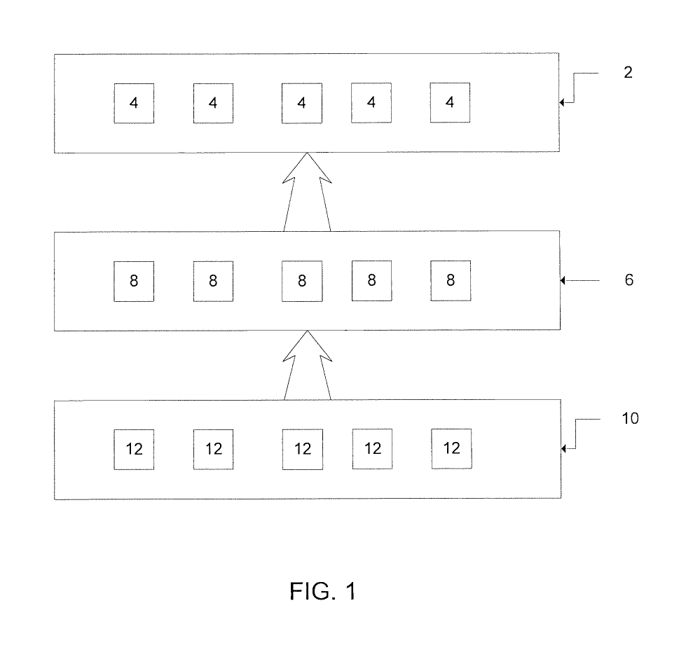

Interrelationships among IT infrastructural resources, business processes, and services may be modeling using techniques described in co-pending U.S. patent application Ser. No. 09/578,156, filed May 23, 200, entitled “Method and Apparatus for Event Correlation in Service Level Management (SLM),” which is hereby incorporated by reference in its entirety. For example, in various implementations, an IT infrastructure may be modeled as illustrated in FIG. 1, where the IT infrastructure may include three layers. A first layer 2 may include a plurality of business processes 4, a second layer 6 may include a plurality services 8 that support or otherwise facilitate optimal operation of the business processes 4, and a third layer 10 may include a plurality of IT resources 12 used to deliver or otherwise support the services 8. Many variations of suitable relationships among business processes, services, and IT infrastructure will be apparent.

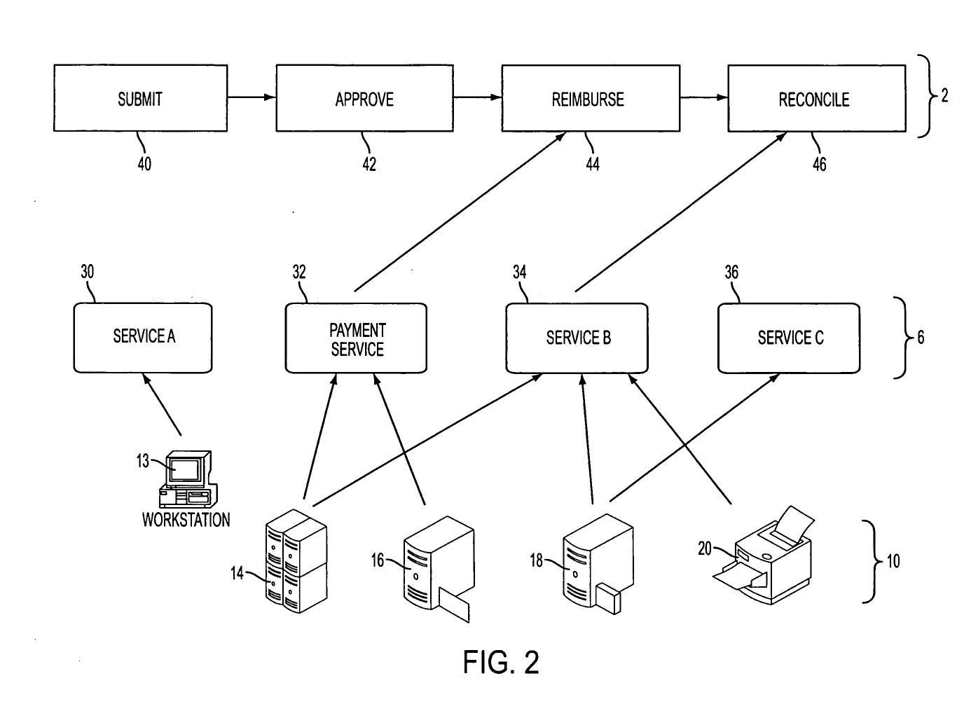

FIG. 2 illustrates an exemplary implementation of a system for diagnosing and managing an information technology infrastructure according to various aspects of the invention. For ease of illustration, the system of FIG. 2 shows a specific, simplified, example of relationships among an IT infrastructure layer 10, a services layer 6 supported by IT infrastructure layer 10, and a business processes layer 2 supported by the services layer 6. It will be understood, however, that the principles and techniques described herein may be applied to any number of suitable IT infrastructures, services, or business processes without departing from the scope and spirit of the invention.

As shown in FIG. 2, IT infrastructure layer 10 may include a plurality of IT resources (e.g., a workstation 13, a network server array 14, an e-mail server 16, a firewall 18, a network printer 20, etc.). Various other resources may be included, such as routers, communication links, printers, wireless access points, hubs, modems, network storage, terminals, personal computers, monitors, input devices, or any other suitable IT resource, as will be apparent. Each of the resources 13-20 in the IT infrastructure layer 10 may relate to one or more services 30, 32, 34, 36 in services layer 6. For example, as illustrated in FIG. 2, the server array 14 and the e-mail server 16 may both relate to a payment service 32 used by an enterprise to process outgoing payments (e.g., to vendors, employee reimbursements, or the like). As shown, the server array 14 may also relate to a generic service B 34, which may also be related to the firewall 18 and the printer 20. For example, the generic service B 34 may be provision of network services (e.g., the server array 14, the firewall 18, and the printer 20 may be coupled via network interfaces to provide network services for the enterprise). Additional relationships between IT resources 10 and services 6 may exist, as illustrated between, for example, the workstation 13 and generic service A 30, and the firewall 18 and generic service C 36.

In turn, the services 30-36 in services layer 6 may relate to business process activities 40-46 in business process layer 2. For example, the business process activities may include an expense submission process 40, an approval process 42, a reimbursement process 44, and a reconciliation process 46, among other things. In this example, the business processes 40-46 included in business process layer 2 may relate to an enterprise's process for reimbursing business-related expenses (e.g., travel expenses, training expenses, etc.), although it will be apparent that any given business, enterprise, or other organization may implement a wide variety of business processes to implement highly diverse business-related objectives.

According to various aspects of the invention, the model as illustrated in FIG. 2 may be produced by various suitable methods. For example, in various implementations, a graphical user interface (GUI) may be used to define business processes, or to select IT services, among other things. Relationships or other associations between the defined business processes and the selected services may be input (e.g., via the GUI, a text input, or other input mechanism). Further, existing models may be imported from other systems or applications, such as models produced using the Casewise® Corporate Modeler Suite™, the Proforma® ProVision® Modeling Suite, Microsoft® Office Visio®, ARIS architecture format, or otherwise. Likewise, models may be imported to depict relationships between the IT infrastructure and the services using a configuration management database, or in other ways, as will be apparent.

In the example of a GUI interface, a user may define relationships by selecting a visually represented service and dragging an arrow or other graphical object representing the relationship to a related business process. Similarly, a user may select a particular business process and use the GUI to associate the business process with one or more related services. As will be apparent, relationships among business processes and services may be populated into a model in order to inform a process of designing an IT infrastructure to support the needs of the business processes and services. For example, the model may be created prior to deploying the IT infrastructure, or created later to map or otherwise model an existing system, or to inform decisions about how to upgrade or restructure the infrastructure, or for other reasons, as will be apparent.

In similar fashion, relationships between services and IT infrastructure resources may be defined using the GUI. Alternatively, certain services may be pre-associated with certain IT infrastructure resources (e.g., a payment service may include a set of hardware resources always or often associated with billing systems). Thus, when populating the model, the IT infrastructure may, in various implementations, automatically include the IT resources required for a service supporting a business process. In various implementations, however, the pre-associated items in the model may be modified or changed by a user. For example, an e-mail server that would normally be associated with a payment service may already be present in the infrastructure to support other services. In such a case, any additional e-mail servers automatically added upon inclusion of a given service may be deleted or merged with the existing e-mail server. In this regard, the model may include representations of various parameters for infrastructure resources (e.g., remaining capacity, usage patterns, etc.), thus informing determinations about whether additional IT sources may be needed to provide modeled services at an optimal level. As such, in various implementations, each modeled service may be associated with an estimated amount of infrastructural support needed to provide the service, thus assisting development of an IT infrastructure that best suits an enterprise's needs (e.g., additional infrastructure may be deployed in advance to prevent anticipated bottlenecks, rather than responding to such issues when they actually occur).

In various implementations, in addition to defining or modeling relationships among business processes, services, and IT resources, associations may be defined among human resources that interact with various aspects of the modeled enterprise. For example, IT resources may be associated with IT human resources (e.g., network administrators, technicians, etc.). Likewise, business processes may be associated with business process human resources (e.g., business developers, billing representatives, salespersons, marketers, etc.). Further, certain human resources may be assigned higher priorities than others (e.g., a network administrator may have a higher priority for dealing with IT resource issues than an ordinary end-user). By way of example, a first business process may be associated with the Chief Financial Officer of an enterprise, while a second business process may be associated with accountants at a lower level of the enterprise hierarchy. In this case, the model may prioritize the first business process and its associated services and IT resources, as compared to the second process and its associated services and IT resources.

By modeling relationships among business processes, services, and IT resources, as described above, changes in status that occur in any aspect of an enterprise can be easily analyzed to determine an impact of the changes. For example, in various implementations, a model may include a visual map of interactions among various aspects of an enterprise, thereby enabling administrators or other users to make resource allocation decisions. In various implementations, impact analysis may be performed automatically using rule-based determinations when a status change occurs. For example, a rule could generate a trouble ticket to replace faulty or overloaded infrastructure resources that have caused service degradation having a financial impact of greater than a determined amount. As another example, certain business processes or services could be designated as mission critical, or prioritized in order of criticality, or according to other parameters. As such, when faulty or outdated infrastructure resources have been mapped to the critical business processes or services, the rules may prioritize replacement or repair of those resources, or may suggest changes to infrastructure resource allocations or organizations to improve support for the critical business processes or services, even if doing so would impact other business processes or services at lower levels of criticality.

Enterprises and IT vendors often enter into contracts for IT services, designating certain services to be critical or otherwise prioritized. These contracts, often referred to as service level agreements (SLAs), may include penalties for when services become unavailable or when service levels degrade below various thresholds. As an example, an SLA may include a clause stating that an IT service provider will be penalized a given amount of money for each hour that a web server fails to function to adequately serve content to users. In such a case, a rule may be designed to take action when detecting a web server outage attributable to a particular IT resource (e.g., a server failure, an overloaded network switch, etc.). For instance, the rule may compare repair and/or replacement costs for the particular IT resource to a price to be paid under the penalty, and a decision may be made based on the comparison (e.g., from the perspective of the service provider, a priority of repairing/replacing the resource may be low for services having low noncompliance penalties, whereas large noncompliance penalties may trigger a higher priority).

The rules for determining impact and appropriate action to be taken may be based on information stored in a look-up table, database, or other information source. For example, the rules may retrieve information from any suitable data repository regarding projected costs for repairing or replacing various infrastructure resources. Likewise, the information source may include data relating to the value of a business process to an enterprise, or the value of an IT service to the enterprise (e.g., as defined in an SLA, or otherwise), or other information, as will be apparent. For example, a dollar value may be associated with a specific instance of a given business process (e.g., in a reimbursement business process, the dollar value may relate to queued reimbursement requests, or in a billing business process, unbilled work may provide a basis for determining the dollar value).

When the dollar values for various business processes cannot be identified, or when strict dollar values do not contribute to key aspects of a decision, priorities may be assigned to status changes in other ways. For example, usage information for particular services or IT resources may be quantified to determine impact from status changes thereto. Thus, when users tend to access the services or resources often or for long durations, then those services or resources may be defined as being more valuable than services or resources accessed rarely or for relatively short periods. On that basis, changes impacting the more highly valued services or resources can be given higher priorities in the model. Likewise, priority metrics may be combined in various ways, such that an infrequently used service having a high dollar value may receive a higher priority than a frequently used but low value service.

For example, an Automated Clearing House interface used once per week for payroll functions for a large number of employees may be more important than a system-wide vending machine inventory performed hourly. In various implementations, to account for enterprise-specific nuances or idiosyncrasies, arbitrary priority or dollar values may be assigned to various aspects of the model by managers of the model.

Using the model illustrated in FIG. 2, an end-user performing reimbursement process 44 may experience an interruption, resulting in the specific business process interruption being characterized by an incident identifier (e.g., Incident 123), impacted human resources (e.g., technology owner Jane Doe), impacted business process (e.g., Expense Reimbursement, Reconciliation Delay), value of the impacted business process (e.g., $23,345.00 based on values of unpaid expenses), and IT resource impact (e.g., replacement cost of $750.00). At a service level of abstraction, a business process interruption may be identified as a result of degradation in a supporting service. Continuing with the same example, assuming that an interruption in payment service 32 caused the interruption to the reimbursement process 44, the service interruption may be similarly parameterized by an incident identifier (e.g., Incident 321), impacted service (e.g., Payment Service), impacted business process (e.g., Expense Reimbursement, Reconciliation, or other impacted business processes), impacted human resources (e.g., technology owner Jane Doe), value of the impacted business process (e.g., $23,345.00 in unpaid expenses, or other values). At an IT infrastructure level of abstraction, the same interruption may be parameterized by an incident identifier (e.g., Incident 789), impacted resource (e.g., e-mail server), impacted business process (e.g., Expense Reimbursement, Reconciliation, or other impacted business processes), impacted human resources (e.g., technology owner Jane Doe), value of the impacted business process (e.g., $23,345.00 in unpaid expenses, SLA violation in 5 minutes, or other values). Each incident ticket may automatically be forwarded to the relevant human resources (e.g., a responsible technical support person).

At each level of abstraction, conveyed information may be interrelated yet tailored using relevant sub-sets of the incident impact, depending on what may be useful or necessary at each level. Furthermore, for a given process interruption, an alarm may be generated to inform relevant personnel. Continuing with the above example, the loss of the e-mail server 16 may result in a message to the technology owner Jane Doe including the Incident Ticket parameters, allowing her to review the situation and pursue a solution. In the given example, Jane Doe may determine that due to the potential SLA violation, she should quickly address the faulty infrastructure component. As will be appreciated, the procedures described above may be initiated by a variety of mechanisms. A business process user may experience an interruption, triggering a phone call, e-mail, or suitable other response to a network administrator, an electronic network administrating system, or otherwise, as will be apparent. In this case, a computerized administration model may automatically reference the model and the associations therein to produce the parameterizations of the interruption, delivering appropriate information to the appropriate recipients, including, for example, technical support personnel responsible for repairing or replacing the associated infrastructure resource. Likewise, failure of an infrastructure resource may automatically result in generation of a trouble ticket and/or a notification to users of impacted business processes.

Implementations of the invention may be made in hardware, firmware, software, or any combination thereof. The invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable storage medium may include read only memory, random access memory, magnetic disk storage media, optical storage media, flash memory devices, and others, and a machine-readable transmission media may include forms of propagated signals, such as carrier waves, infrared signals, digital signals, and others. Further, firmware, software, routines, or instructions may be described in the above disclosure in terms of specific exemplary aspects and implementations of the invention, and performing certain actions. However, those skilled in the art will recognize that such descriptions are merely for convenience and that such actions in fact result from computing devices, processors, controllers, or other devices executing the firmware, software, routines, or instructions.

Aspects and implementations may be described as including a particular feature, structure, or characteristic, but every aspect or implementation may not necessarily include the particular feature, structure, or characteristic. Further, when a particular feature, structure, or characteristic is described in connection with an aspect or implementation, it is understood that it is within the knowledge of one skilled in the art to effect such feature, structure, or characteristic in connection with other aspects or implementations whether or not explicitly described. Thus, various changes and modifications may be made, without departing from the scope and spirit of the invention. The specification and drawings are to be regarded as exemplary only, and the scope of the invention is to be determined solely by the appended claims.

What is claimed is:

1. A method for diagnosing and managing an information technology infrastructure, comprising:
defining associations among a plurality of information technology resources, a plurality of services supported by the information technology resources, and a plurality of business processes supported by the services;
identifying a status change for at least one of the information technology resources, the services, or the business processes;
determining an impact of the identified status change based on the defined associations, the determined impact relating to a cost of the identified status change on information technology resources, services, or business processes impacted by the identified status change; and
performing at least action in response to the determined impact.

2. The method of claim 1, the cost including financial costs and non-financial costs associated with the identified status change.

3. The method of claim 2, the financial costs including costs to restore a degraded information technology resource impacted by the identified status change.

4. The method of claim 2, the financial costs including costs to restore a degraded service impacted by the identified status change or a penalty for failing to restore the degraded service.

5. The method of claim 2, the financial costs including losses to an enterprise caused by a business process being interrupted by the identified status change.

6. The method of claim 2, the non-financial costs including priorities or conditions defined in a service level agreement between an enterprise and an information technology service provider.

7. The method of claim 2, the non-financial costs including usage information for information technology resources, services, or business processes impacted by the identified status change.

8. The method of claim 2, the non-financial costs including value metrics associated with an entity impacted by the identified status change, the value metrics based on the entity's role within an enterprise hierarchy.

9. The method of claim 1, the defined associations further including relationships between a plurality of entities and the information technology resources, the services, and the business processes, the method further comprising:
identifying at least one of the entities impacted by the identified status change, the identified entity responsible for remedying the determined impact to the information technology resources, the services, and/or the business processes.

10. The method of claim 9, wherein performing the action includes notifying the identified entity of the determined impact.

11. The method of claim 1, further comprising generating an incident ticket corresponding to the identified status change, the generated ticket assigned a relative priority based on the determined impact.

12. A system for diagnosing and managing an information technology infrastructure, comprising:
an information technology infrastructure including a plurality of information technology resources;
a data repository storing information relating to the information technology resources, a plurality of information technology services supported by the information technology resources and a plurality of enterprise business processes supported by the services; and
at least one computer readable medium storing computer executable instructions for managing the information technology resources, the services, and the business processes, the instructions operable to:
process associations among the information technology resources, the services, and the business processes;
identify a status change for at least one of the information technology resources, the services, or the business processes;
determine an impact of the identified status change based on the defined associations, the determined impact relating to a cost of the identified status change on information technology resources, services, or business processes impacted by the identified status change; and
perform at least action in response to the determined impact.

13. The system of claim 12, the cost including financial costs and non-financial costs associated with the identified status change.

14. The system of claim 13, the financial costs including costs to restore a degraded information technology resource impacted by the identified status change.

15. The system of claim 13, the financial costs including costs to restore a degraded service impacted by the identified status change or a penalty for failing to restore the degraded service.

16. The system of claim 13, the financial costs including losses to an enterprise caused by a business process being interrupted by the identified status change.

17. The system of claim 13, the non-financial costs including priorities or conditions defined in a service level agreement between an enterprise and an information technology service provider.

18. The system of claim 13, the non-financial costs including usage information for information technology resources, services, or business processes impacted by the identified status change.

19. The system of claim 13, the non-financial costs including value metrics associated with an entity impacted by the identified status change, the value metrics based on the entity's role within an enterprise hierarchy.

20. The system of claim 12, the processed associations further including relationships between a plurality of entities and the information technology resources, the services, and the business processes, the instructions further operable to:
identify at least one of the entities impacted by the identified status change, the identified entity responsible for remedying the determined impact to the information technology resources, the services, and/or the business processes.

21. The system of claim 20, the instructions operable to perform the action by notifying the identified entity of the determined impact.

22. The system of claim 12, the instructions further operable to generate an incident ticket corresponding to the identified status change, the generated ticket assigned a relative priority based on the determined impact.
